(19) United States
(12) Patent Application Publication
(10) Pub. No.: US 2012/0066423 A1
(43) Pub. Date: Mar. 15, 2012

(54) INTER-INTEGRATED CIRCUIT BUS MULTICASTING

(76) Inventors: Boon Siang Choo, Singapore (SG); Tzye Perng Poh, Shah Alam Selangor (SG); Chee How Lee, Singapore (SG)

(21) Appl. No.: 12/880,975

(22) Filed: Sep. 13, 2010

(51) Int. Cl. G06F 13/40

(52) U.S. Cl. 710/110

(57) ABSTRACT

A master node selects a plurality of slave nodes that share a common slave address to receive a data communication. The master node multicasts the data communication to the plurality of selected slave nodes via an inter-integrated circuit bus having a serial data line and a serial clock line.

### BACKGROUND

The inter-integrated circuit (or I²C) bus (created by Royal Philips Electronics Inc. of Amsterdam, the Netherlands) is a multi-master serial single-ended computer bus frequently used to attach peripherals to a motherboard, embedded system, cell phone, etc. In particular, an I²C bus is a two-wire bus that includes a serial data line (SDA) and a serial clock line (SCL). In networking, I²C communications can be used to configure a group of slave nodes. Given the nature of the I²C bus and corresponding protocol, in situations where a group of slave nodes share a common slave address, a master node selects and communicates with each slave node separately even if the master node is repeating the same communication to each of the slave nodes.

### BRIEF DESCRIPTION OF DRAWINGS

The following description includes discussion of figures having illustrations given by way of example of implementations of embodiments of the invention. The drawings should be understood by way of example, not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram illustrating a system according to various embodiments.

FIG. 2 is a block diagram illustrating a system according to various embodiments.

FIG. 3 is a flow diagram of operation in a system according to various embodiments.

FIG. 4 is a flow diagram of operation in a system according to various embodiments.

### DETAILED DESCRIPTION

Embodiments described herein facilitate expansion of a single I²C bus to multiple devices, allowing a master node to perform one-to-one, one-to-many, and/or one-to-all communications with slave nodes. Various types of networking devices (e.g. a router, switch, network card, media converter, etc.) might employ a master node (e.g., mother board, CPU, ASIC, etc.) that communicates with multiple slave nodes via I²C communications. For example, the master node might be responsible for configuring a group of slave nodes. In certain situations, the slave nodes might share a common slave address. For example, the slave nodes might be SFP (small form-factor pluggable) transceivers that connect the master node to a networking cable such as a fiber-optic or copper networking cable.

To communicate over an I²C bus with multiple slave nodes sharing the same slave address, a multiplexer can be used to segregate the slave nodes from each other. Examples of multiplexers include a pass-through FET (field effect transistor) multiplexer and an I²C-controlled multiplexer. However, given the limitations of the I²C bus and corresponding protocol, the master node communicates with each slave node individually. In other words, each time the master node finishes communicating with one slave node, it selects the next slave node and then starts communicating with that slave node. This successive serial communication with the various slave nodes takes place even if the master node is repeating the same communication to each slave node (which is the case, for example, during SFP transceiver initialization). Thus, the time required to configure a networking device that has multiple slave nodes may increase with the number of slave nodes.

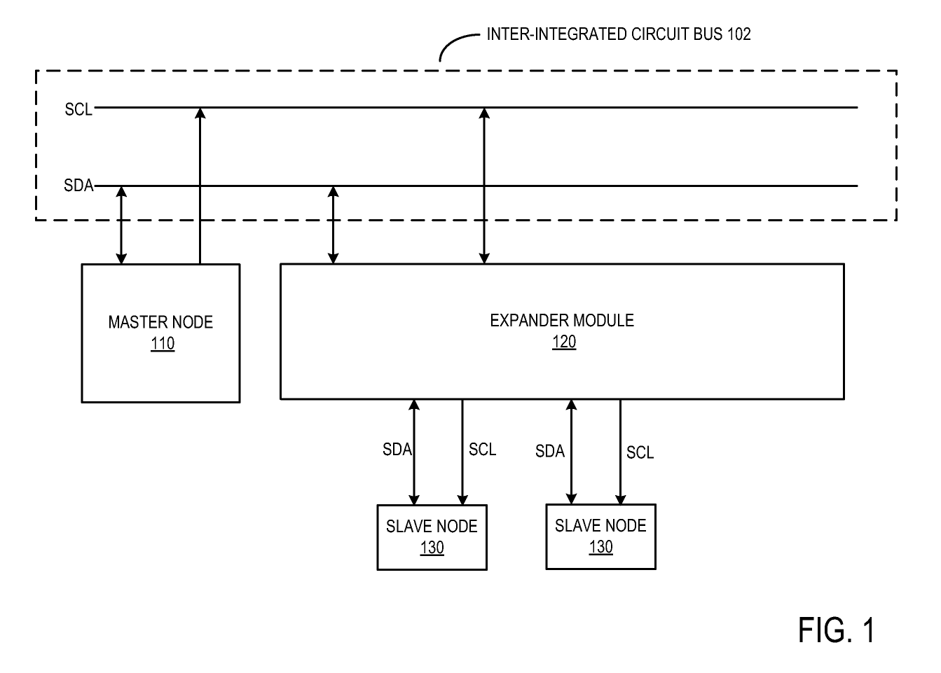

FIG. 1 is a block diagram illustrating a system according to various embodiments. FIG. 1 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

In FIG. 1, an I²C expander module 120 is connected to the serial data line (SDA) and serial clock line (SCL) of I²C bus 102. Expander module 120 may be implemented as a PLD (programmable logic device), FPGA (field-programmable gate array), an integrated circuit, or other suitable device. Expander module 120 facilitates broadcasting and/or multicasting from master node 110 (e.g., a CPU, ASIC, etc.) to configure a group of slave nodes 130 (e.g., SFP transceivers) that share a common slave address. Broadly defined, a broadcast is a transmission to multiple, unspecified recipients. A multicast is defined as a transmission to multiple, specified recipients. To overcome the serial limitations of the I²C protocol and I²C bus 102, master node 110 achieves broadcasting and/or multicasting inasmuch as master node 110 sends a single data communication on I²C bus 102 that ultimately and automatically reaches multiple specified or unspecified slave nodes 130 by way of expander module 120.

Master node 110 selects one or more slave nodes 130 to receive a communication and sends the selection with the communication to expander module 120 via the I²C protocol. In one example, the communication includes configuration information (e.g., for an SFP transceiver). Via the use of various registers, expander module 120 propagates the communication to selected slave nodes 130.

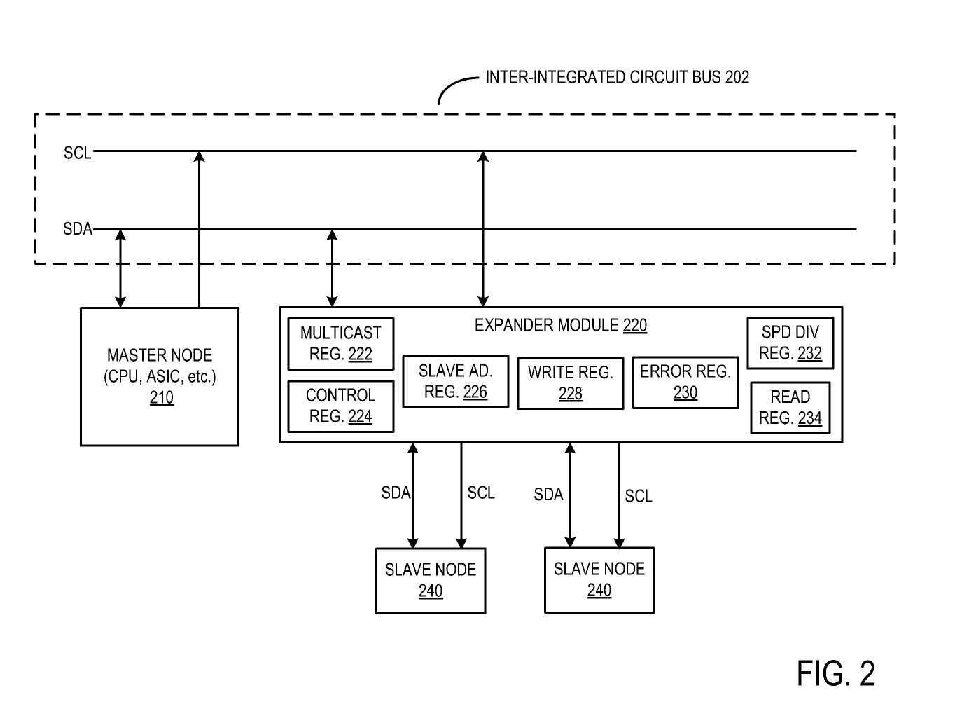

FIG. 2 is a block diagram of system according to various embodiments. FIG. 2 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

Similar to FIG. 1, I²C expander module 220 is connected to the serial data line (SDA) and serial clock line (SCL) of an I²C bus 202. Again, expander module 220 may be implemented as a PLD (programmable logic device), FPGA (field-programmable gate array), an integrated circuit, or other suitable device. Expander module 220 includes various registers to facilitate broadcasting and/or multicasting from master node 210 (e.g., a CPU, ASIC, etc.) to configure a group of slave nodes 240 that share a common slave address.

Master node 210 controls various register values on expander module 220. In some embodiments, master node 210 sets register values automatically based on predefined settings. In other embodiments, master node 210 sets register values on expander module 220 in response to user input. For example, in various embodiments master node 210 sets slave address register 226 to a common slave address (e.g., an 8-bit slave address) for slave nodes 240. In alternate embodiments, expander module 220 could include a separate slave address register for each slave node, thereby allowing master node 210 to set each slave address individually.

Master node 210 sets write register 228 to include the data (e.g., configuration data) to be sent to selected slave nodes. Particular slave nodes are selected via multicast register 222. One slave node, many slave nodes or all slave nodes may be selected via multicast register 222. Multicast register 222 may additionally include a broadcast bit that can be selected to broadcast data to all slave nodes 240.

Control register 224 includes various bits that are also controlled and/or set by master node 210. As discussed above, multicast register 222 may include a broadcast bit. Alternatively, control register 224 may contain a broadcast bit that, when selected, sends data to all slave nodes 240. A read/write bit on control register 224 determines whether a read or write operation is to be performed by expander module 220.

A start bit on control register 224, when asserted by master node 210, starts I²C communications. A combined ACK (acknowledgement) bit indicates whether or not all slave nodes 240 have responded with a proper ACK. Thus, if one or more slave nodes fail to acknowledge a communication sent from master node 210, such slave nodes may be removed from receiving future broadcasts and/or multicasts.

Error register 230 includes one bit for each slave node to track communication errors on a per slave node basis. If the error bit for a particular slave node indicates a communication error, master node 210 can choose (e.g., automatically or in response to user input) to remove the slave node from multicast list.

Speed divisor register 232 controls the operating frequency of I²C bus 202. Register 232 may be set automatically by master node 210 based on a predefined value or current conditions, or it may be set in response to user input.

Read data register 234 stores reply messages and/or data from slave nodes 240 in response to communications from master node 210. Read data register 234 can be a single register for all slave nodes 240 or it may be implemented as a single register for each of slave nodes 240. In embodiments with a register for each slave node, master node 210 read out data from each read register in serial fashion.

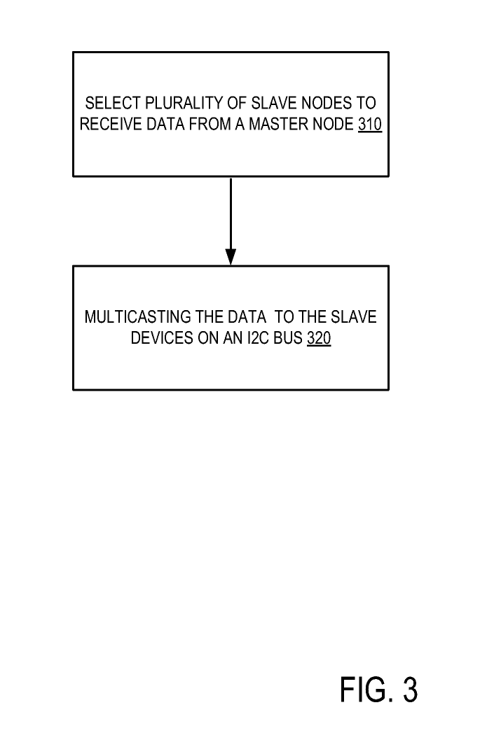

FIG. 3 is a flow diagram of operation in a system according to various embodiments. FIG. 3 includes particular operations and execution order according to certain embodiments. However, in different embodiments, other operations, omitting one or more of the depicted operations, and/or proceeding in other orders of execution may also be used according to teachings described herein.

A master node selects 310 a plurality of slave nodes to receive data from the master node. The master node sends 320 a data communication (that includes the data for the slave nodes and additional information) onto an I²C bus (having a serial data line and a serial clock line) for receipt by the slave nodes. An expander module on the I²C bus, acting as an intermediary between the master node and the slave nodes, receives the data communication to facilitate the multicast to the selected slave nodes. In particular, the additional information in the data communication includes register values to be applied to various registers in the expander module. For example, if the slave nodes share a common slave address, the additional information causes a slave address register on the expander modules to be set to the common slave address for all of the slave nodes. Alternatively, if each slave node has a different slave address, the additional information could cause each of a plurality of slave address registers to be set to a respective slave address.

In another example, the additional information in the data communication causes the data intended for the slave nodes to be written to a write data register. In yet another example, the additional information in the data communication causes various register bits in a multicast register to be set, indicating which slave nodes are intended to receive the data from the master node.

Given the operations described with respect to FIG. 3, a master node connected to an I²C bus is able to send data to a plurality of slave nodes via a single communication. In other words, a master node connected to an I²C bus can avoid having to send the same data multiple times to reach each of the respective slave nodes.

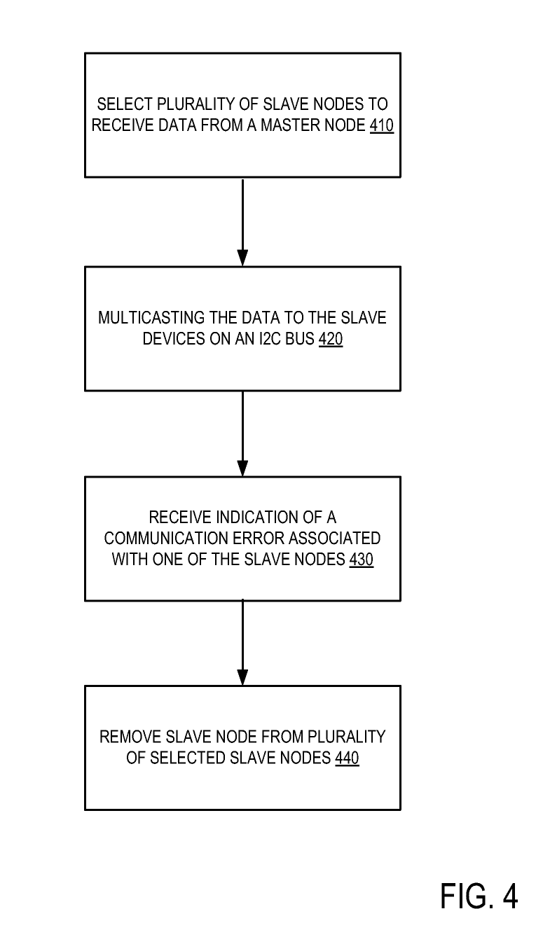

FIG. 4 is a flow diagram of operation in a system according to various embodiments. FIG. 4 includes particular operations and execution order according to certain embodiments. However, in different embodiments, other operations, omitting one or more of the depicted operations, and/or proceeding in other orders of execution may also be used according to teachings described herein.

Similar to the operations of FIG. 3, a master node selects 410 a plurality of slave nodes to receive data from the master node. The master node sends 420 a data communication (that includes the data for the slave nodes and additional information) onto an I²C bus (having a serial data line and a serial clock line) for receipt by the slave nodes. As described above, an expander module on the I²C bus, acting as an intermediary between the master node and the slave nodes, receives the data communication to facilitate the multicast to the selected slave nodes. In particular, the additional information in the data communication may include data for populating various registers that control the multicasting of data from the master node to various slave nodes.

The master node receives 430 an indication of a communication error associated with at least one slave node. For example, the expander module might include an error register that sets a flag for each slave node that does not provide a proper acknowledge in response to receiving data from the master node. In response to receiving the indication of the communication error, the master node removes 440 the slave node associated with the communication error from the list of selected slave nodes.

Various modifications may be made to the disclosed embodiments and implementations of the invention without departing from their scope. Therefore, the illustrations and examples herein should be construed in an illustrative, and not a restrictive sense.

1. An apparatus, comprising:
an inter-integrated circuit bus having a serial data line and a serial clock line;
a master node;
a plurality of slave nodes having a common slave address; and
an expander module connected with the inter-integrated circuit bus to facilitate selective multicasting from the master node to the plurality of slave nodes via the inter-integrated circuit bus.

2. The apparatus of claim 1, wherein each of the plurality of slave nodes comprises a small form-factor pluggable (SFP) transceiver.

3. The apparatus of claim 1, wherein the expander module further comprises:
a slave address register to define the common slave address for the plurality of the slave nodes.

4. The apparatus of claim 1, wherein the expander module further comprises:
a speed divisor register to control an operating frequency of the inter-integrated circuit bus.

5. The apparatus of claim 1, wherein the expander module further comprises:
a read data register for each of the plurality of slave nodes.

6. The apparatus of claim 1, wherein the expander module further comprises:
a multicast register to select which of the plurality of slave nodes to receive a communication from the master node.

7. The apparatus of claim 1, wherein the expander module further comprises:
a write data register to set data to be sent to the plurality of slave nodes.

8. The apparatus of claim 1, wherein the expander module further comprises:
a slave address register for each of the plurality of slave nodes.

9. A method, comprising:
a master node selecting a plurality of slave nodes to receive a data communication, the slave nodes sharing a common slave address;
multicasting the data communication from the master node to the plurality of selected slave nodes via an inter-integrated circuit bus having a serial data line and a serial clock line.

10. The method of claim 9, wherein the data communication comprises data to configure the slave nodes.

11. The method of claim 9, further comprising:
receiving an indication of a communication error associated with one of the plurality of slave nodes; and
removing the slave node associated with the communication error from the plurality of selected slave nodes to prevent the slave node from receiving future data communications.

12. The method of claim 9, further comprising:
modifying an operating frequency of the inter-integrated circuit bus in response to user input.

13. An apparatus, comprising:
a single inter-integrated circuit bus having a serial data line and a serial clock line;
a master node;
a plurality of slave nodes having a common slave address; and
an expander module on the inter-integrated circuit bus to support broadcasting data from the master node to the plurality of slave nodes via the inter-integrated circuit bus.

14. The apparatus of claim 13, wherein each of the plurality of slave nodes comprises a small form-factor pluggable (SFP) transceiver.

15. The apparatus of claim 13, wherein the expander module further comprises:
a slave address register to define the common slave address for the plurality of the slave nodes.

16. The apparatus of claim 13, wherein the expander module further comprises:
a speed divisor register to control an operating frequency of the inter-integrated circuit bus.

17. The apparatus of claim 13, wherein the expander module further comprises:
a read data register for each of the plurality of slave nodes.

18. The apparatus of claim 13, wherein the expander module further comprises:
a multicast register to select which of the plurality of slave nodes to receive a communication from the master node.

19. The apparatus of claim 13, wherein the expander module further comprises:
a write data register to set data to be sent to the plurality of slave nodes.
